(19) United States
(12) Patent Application Publication
(10) Pub. No.: US 2009/0213744 A1
(43) Pub. Date: Aug. 27, 2009

(54) Self-testing communications device

(75) Inventor: Rafael Nenna, Emmerthal (DE)

Correspondence Address: DeMont & Breyer, LLC, 100 Commons Way, Ste. 250, Holmdel, NJ, 07733, US

(73) Assignee: PHOENIX CONTACT GMBH & CO. KG, Blomberg (DE)

(21) Appl. No.: 12/388,841

(22) Filed: Feb. 19, 2009

(30) Foreign Application Priority Data
Feb. 27, 2008 (DE) 10 2008 011 346.8

(51) Int. Cl. G08C 15/00; H04L 12/26; G06F 19/00

(52) U.S. Cl. 370/252; 702/179

(57) ABSTRACT

The invention relates to a communications device with a transmitter (101) for transmitting a predetermined message via a communications network, a receiver (103) for receiving a reply to the predetermined message via the communications network, and a processor (105) designed to detect a time interval between the transmission of the predetermined message and the reception of the reply and to assign this time interval to a predetermined measurement interval.

### FIELD OF THE INVENTION

The present invention relates to the field of communications systems.

### BACKGROUND OF THE INVENTION

An important feature for the qualification of wireless and wired communications systems is their transmission rate, as well as jitter. In the current state of the art, these parameters are determined during the development phase, and the result of the determination is then specified in a data sheet as a typical parameter. However, the actually achievable performance, for example, a transmission rate of a wireless communications system, is also subject to, in particular, local conditions at an installation site. Thus, for example, the quality of a local radio field has a strong influence on the performance of a wireless communications system located in this field. During a transmission, if an error occurs due to the radio field, then message packets can be transmitted again within the bounds of a retransmission that generates an unpredictable time delay.

In addition to the local conditions, the number of possible settings and/or parameters in the communications system at the installation site also has an influence on the resulting performance. Here, however, the effectiveness of the optimization parameter often cannot be determined immediately. Under certain circumstances, the application of some optimization measures can produce combinations that may improve or exacerbate the performance of the corresponding communications system.

The sum of the factors influencing the performance of a communications system is therefore difficult to predict, so that the user of the communications system often must execute the performance measurements separately. These measurements, however, are associated with significant expense and, furthermore, often must be performed indirectly with a higher-level communications system, as well as special, additional measurement structures. The accuracy of the culminating measurement results is also often low.

### SUMMARY OF THE INVENTION

The problem of the present invention is to devise an efficient testing concept for communications devices.

This problem is solved by the features of the independent claims. Advantageous refinements are specified in the dependent claims.

The invention relates to a communications device that can perform a self-test, for example, in the field. The communications device, for example, a base station, can independently generate, for example, an increased data rate that is higher than, for example, an average data rate to be expected. For this purpose, for example, specially predetermined messages can be transmitted to one or more communications receivers via a communications network using, for example, Bluetooth. The communications receivers typically acknowledge the reception of the received message with a special reply, so that the time that has elapsed between the transmission of the predetermined message and the reception of the reply can be measured. Preferably, however, not every individual measurement value is stored. Instead, each measurement result can be assigned to a determined measurement interval from a plurality of measurement intervals, for example, from 0 to 100 ms, spaced apart at 1-ms steps. Here, only the number of hits, i.e., the measurement results, per interval can also be stored, which leads to a large compression of the resulting data set and allows an implementation of the method with microcontrollers.

The highest possible data rate is selected, for example, so that several 10,000's of measurements are possible, to produce a sufficiently large statistical analysis. For this number of messages, as stated above, preferably only the number of measurement results assigned to one measurement interval are retained, so that the storage of the individual measurement values is unnecessary.

The invention relates to a communications device with a transmitter for transmitting a predetermined message via a communications network, a receiver for receiving a reply to the predetermined message via the communications network, and a processor designed to detect a time interval between the transmission of the predetermined message and the reception of the reply and to assign this time interval to a predetermined measurement interval.

According to one embodiment, the transmitter is designed to transmit the predetermined message via the communications network to a plurality of communications receivers, wherein the receiver is designed to receive a number of replies responding to the predetermined message, and wherein the processor is designed to detect the number of time intervals between the transmission of the predetermined message and a reception of the corresponding reply and to assign the time interval to one or more measurement intervals.

According to one embodiment, the time interval can be assigned to one measurement interval from a plurality of measurement intervals.

According to one embodiment, the communications device includes a storage element for storing a number of time intervals assigned to the measurement interval.

According to one embodiment, the processor is further designed to determine a transmission rate, in particular, an average transmission rate, or a system parameter, in particular, an average system parameter, on the basis of a number of time intervals assigned to one measurement interval.

According to one embodiment, the processor is designed to adaptively set a system parameter on the basis of the time interval or on the basis of a number of time intervals assigned to one or more measurement intervals.

According to one embodiment, the processor is designed to determine a statistical average across a number of time intervals assigned to one or more measurement intervals.

According to one embodiment, the time period of the measurement interval or intervals has a configurable structure.

According to one embodiment, the processor is designed to determine a statistical minimum and/or a statistical maximum across the entire measurement period.

The invention further relates to a communications method with the transmission of a predetermined message via a communications network, reception of a reply to the predetermined message via the communications network, detection of a time interval between the transmission of the predetermined message and the reception of the reply, and assignment of the detected time interval to a predetermined measurement interval.

### BRIEF DESCRIPTION OF THE DRAWINGS

Additional embodiments will be explained with reference to the accompanying drawings. Shown are:

FIG. 1, a communications device, and

FIG. 2, a communications scenario with an example data set.

### DETAILED DESCRIPTION

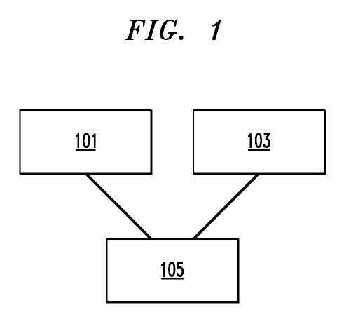

The communications device shown in FIG. 1 includes a transmitter for transmitting a predetermined message via a communications network to one or more communications network subscribers. The communications device further includes a receiver 103 for receiving a reply to the predetermined message via the communications network, for example, via Bluetooth, from one or more network subscribers. A processor 105 that detects, for example, one or more time intervals between the transmission of the predetermined message and the reception of the reply, and that assigns these time intervals to a predetermined measurement interval is connected after the receiver 103.

The transmitter 101 and the receiver 103 can involve, for example, standard communications components provided for standard communications via the communications network.

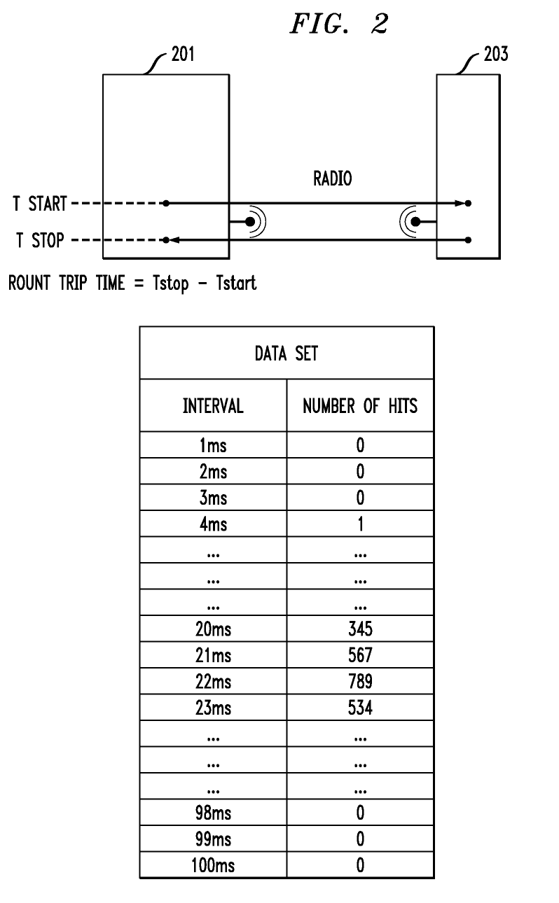

FIG. 2 shows a communications device 201, for example, a Bluetooth base station that communicates with a receiver 203 via, for example, a radio channel. The base station 201 is provided to determine, as a system parameter, for example, the roundtrip time that has elapsed between a transmission of the predetermined message and the reception of the reply to this message. Preferably, the base station 201 is designed to determine a difference between Tstop and Tstart, that is, between a time at which the reply was received and a time at which the predetermined message was transmitted.

The communications device 201 can have, for example, the features of the communications device shown in FIG. 1.

FIG. 2 further illustrates, for example, a data set with a number of measurement intervals divided into 1-ms steps. Thus, for example, only one measurement result falls within the interval of 4 ms. In the interval of 20 ms, for example, 345 measurement results are recorded, in the interval of 21 ms, 567 measurement results are recorded, in the interval of 22 ms, 789 measurement results are recorded, and in the interval of 23 ms, 534 results are recorded. On the basis of these measurement results, an average roundtrip time, as well as, for example, also minimum and maximum roundtrip times and/or an average transmission rate can be determined.

According to one embodiment, the communications device can include, for example, a memory that is, for example, approximately 200 bytes large, to perform, for example, 65,000 measurements. Such roundtrip times of approximately 30 ms, therefore, allow a measurement period of approximately 32 min under consideration of expected measurement results below 100 ms and a measurement granularity of 1 ms per time interval. By reserving, for example, 400 bytes, a long-term measurement of, for example, approximately 4 years can be performed, so that a statistical measurement analysis across this time span is possible.

Furthermore, the communications device shown in FIG. 2 can have a controllable configuration, so that it can be activated remotely.

The concept according to the invention puts a communications system in the position to determine the actual performance in the field under consideration of all of the settings, as well as the quality of the local radio field, and to perform a self-test. Thus it is possible, for example, to trigger messages, for example, after a change in a local parameter on the side of a user, to be able to evaluate the effects of this change directly and with reference to measurement results.

The measurement values can be evaluated analytically, which can be performed automatically in the communications device. The measurements can be repeated with different parameters, wherein the communications device itself can determine the most favorable system parameters and optimally can set these, for example, adaptively. The communications device could also be set adaptively and optimized for performance with reference to the local conditions.

The concept according to the invention can be used not only in Bluetooth or WLAN networks (WLAN: Wireless Local Area Network), but instead can be applied anywhere transmission properties can be determined only at the installation site.

1. Communications device comprising:
a transmitter (101) for transmitting a predetermined message via a communications network;
a receiver (103) for receiving a reply to the predetermined message via the communications network; and
a processor (105) designed to detect a time interval between the transmission of the predetermined message and the reception of the reply and to assign the time interval to a predetermined measurement interval.

2. Communications device according to claim 1, wherein the transmitter (101) is designed to transmit the predetermined message via the communications network to a plurality of communications receivers, wherein the receiver (103) is designed to receive a number of replies responding to the predetermined message, and wherein the processor (105) is designed to detect the number of time intervals between the transmission of the predetermined message and a reception of the corresponding reply and to assign the time intervals to one or more measurement intervals.

3. Communications device according to claim 1, wherein the time interval can be assigned to one measurement interval from a plurality of measurement intervals.

4. Communications device according to claim 1 further comprising a memory element for storing a number of time intervals assigned to the measurement interval.

5. Communications device according to claim 1, wherein the processor (105) is further designed to determine a transmission rate or a system parameter on the basis of a number of time intervals assigned to one measurement interval.

6. Communications device according to claim 1, wherein the processor (105) is designed to adaptively set a system parameter on the basis of the time interval or on the basis of a number of time intervals assigned to one or more measurement intervals.

7. Communications device according to claim 1, wherein the processor (105) is designed to determine a statistical average across a number of time intervals assigned to one or more measurement intervals.

8. Communications device according to claim 1, wherein the time period of the measurement interval or intervals is configurable.

9. Communications device according to claim 1, wherein the processor (105) is designed to determine a statistical minimum or a statistical maximum across a total measurement period.

10. (canceled)

11. Communications device according to claim 5, wherein the transmission rate is an average transmission rate.

12. Communications device according to claim 5, wherein the system parameter is an average system parameter.

13. Communications method comprising:
transmitting a predetermined message via a communications network;
receiving a reply to the predetermined message via the communications network;
detecting a time interval between the transmission of the predetermined message and the reception of the reply; and
assigning the detected time interval to a predetermined measurement interval.
